(19) United States
(12) Patent Application Publication
(10) Pub. No.: US 2014/0281802 A1
(43) Pub. Date: Sep. 18, 2014

(54) MULTI-DIMENSIONAL ERROR DETECTION AND CORRECTION MEMORY AND COMPUTING ARCHITECTURE

(71) Applicant: SEAKR ENGINEERING, INC., Centennial, CO (US)

(72) Inventor: Michael Coe, Centennial, CO (US)

(73) Assignee: SEAKR ENGINEERING, INC., Centennial, CO (US)

(21) Appl. No.: 13/835,432

(22) Filed: Mar. 15, 2013

(51) Int. Cl. G06F 11/10

(52) U.S. Cl. CPC G06F 11/10
USPC 714/763

(57) ABSTRACT

Error correction and detection may be performed across multiple dimensions of memory storage, such as across two or more complete memory devices, as well as within individual pages of memory within a single memory device. Error correction and detection performed across two or more complete memory devices may mitigate single event functional interrupts that affect a complete memory device. Error detection and correction performed within individual pages of memory may be used to mitigate single event upset induced single and multiple bit flips within a page of a memory device. A parallel or serial block code, such as a parallel or serial block Reed-Solomon code or any other type of error correcting code, may be used for error correction and detection performed across two or more complete memory devices or within individual pages of memory within a single memory device.

### FIELD

The present disclosure relates generally to computing and/or memory architectures and, more specifically, to robust error detection and correction in computing and/or memory architectures.

### BACKGROUND

Various techniques are known for error detection and correction in computing systems. In data storage applications, error detection and correction codes may be used to improve the reliability of data storage media. For example, some file formats include a checksum, such as CRC32, to detect corruption and truncation and can employ redundancy and/or parity files to recover portions of corrupted data. Additionally, Reed/Solomon codes (or any other type of error correcting code) may be used to correct some errors, and storage media may use CRC codes to detect and Reed/Solomon codes to correct minor errors, such as errors in sector reads when using a hard disk drive, for example. In some applications, solid state memory may provide increased protection against soft errors by employing error correcting codes. Such memory may be used in applications having harsh environmental conditions or applications that have little or no margin for errors in data. For example, in a space environment, radiation effects may require that various electronic designs be capable of high-reliability even in the event of radiation effects on the electronic systems.

For example, radiation effects on electronics systems in a space environment may induce one or more types of errors in electronic components. Single event type errors can occur at any point in the mission duration. Such radiation effects include single event upset (SEU), multiple bit upset (MBU), single event functional interrupt (SEFI), and single event transient (SET) errors. SEU, MBU, SEFI, and SET generally require mitigation at the board or system level. Some classes of these errors may require ground intervention. In any event, high reliability systems to be used in such applications may be required to continue operation after such events with little or no external intervention.

### SUMMARY

Methods, systems, and devices for error detection and correction are provided, Error correction and detection may be performed across multiple dimensions of memory storage, such as across two or more complete memory devices, as well as within individual pages of memory within a single memory device. Error correction and detection performed across two or more complete memory devices may mitigate single event functional interrupts that affect a complete memory device. Error detection and correction performed within individual pages of memory may be used to mitigate single event upset induced single and multiple bit flips within a page of a memory device. A parallel block code, such as a parallel block error correcting code, may be used for error correction and detection performed across two or more complete memory devices. A serial block code, such as a serial block error correcting code, may be used for error correction and detection within individual pages of memory within a single memory device. According to various aspects, parallel block codes also may be used for error correction and detection within individual pages of memory within a memory device.

According to one set of embodiments, a processing system is provided that includes a processor module; a memory module coupled to the processor module comprising a plurality of memory devices, each of the memory devices configured to store data in a predefined plurality of memory pages within the device; and an error detection and correction module coupled with the processor module and memory module and configured to perform first error detection and correction encoding on data to be stored across a plurality of the memory devices and second error detection and correction encoding of data to be stored within pages of data to be stored within one or more of the plurality of memory devices. The first error detection and correction may be performed using a parallel block code encoded across the plurality of memory devices. The second error detection and correction may be performed using a serial block code encoded in the plurality of pages within the one or more memory devices. Serial or parallel block codes that may be used may include any suitable type of error correcting code, such as, for example, Reed-Solomon, Hamming, cyclic error-correcting codes such as BCH, forward error correction codes such a's turbo codes, low density parity check (LDPC) codes, and triple majority voting (TMV), etc. According to various embodiments, the order in which the error detection and correction using serial or parallel block codes may be order independent, and either a parallel or serial block code may be used across the plurality of memory devices, and the other of a serial or parallel block code may be encoded in the plurality of pages within the one or more memory devices. In some embodiments, serial or parallel block encoded data is stored within each of the subset of memory devices in spare memory storage at the end of each memory page.

The first error detection and correction encoding may be configured to mitigate single event functional interrupts that affect a complete memory device, and the second error detection and correction encoding may configured to mitigate single event upset induced single and multiple bit flips within a page of a memory device. The plurality of memory devices may comprise, for example, one or more arrays of flash-based memory devices. According to various examples, other types of memory may be used, such as, for example, (1) NAND and NOR Flash memory including single level and multi-level cells, (2) Ferroelectric RAM (FeRAM, F-RAM, FRAM), (3) Magnetoresistive RAM (MRAM) including memories based on spin torque transfer (STT), (4) Phase-change RAM (PRAM), (5) memristor based memory, (6) Silicon-oxide-nitride-oxide-silicon (SONOS), (7) Resistive RAM (RRAM, ReRAM), (8) Programmable metallization cell (PMC) including conductive-bridging RAM (CBRAM) also known as electrolydic memory, (9) Carbon-nanotube RAM (CNT RAM), (10) Phase-change memory (PRAM, PCRAM, Chalcogenide RAM, C-RAM, CRAM), (11) Dynamic RAM (DRAM) including thyristor RAM (T-RAM), and/or (12) Static RAM (SRAM). The first and second error detection and corrections may be configured to mitigate space radiation effects on the plurality of memory devices.

According to other sets of embodiments, methods for error detection and correction are provided. Exemplary methods may include receiving data to be stored in a memory module, the memory module comprising a plurality of memory devices, each of the memory devices configured to store data in a predefined plurality of memory pages within the device; firstly encoding data to be stored across a plurality of the memory devices according to a first error detection and correction code; and secondly encoding data to be stored in one or more pages of data within one or more of the plurality of memory devices according to a second error detection and correction code. Methods according to various embodiments may also include storing the firstly encoded data in a predefined location in one or more of the memory devices; and storing the secondly encoded data at the end of each respective memory page in which the data is stored. The first error detection and correction code may include parallel block code encoded across the plurality of memory devices. The second error detection and correction code may include serial block code for encoding of data stored within a page of data within the one or more memory devices. According to some embodiments, the first error detection and correction code may include serial block code encoded across the plurality of memory devices, and the second error detection and correction code may include parallel block code for encoding of data stored within a page of data within the one or more memory devices. The first error detection and correction code may be used to mitigate single fault functional interrupts that affect a complete memory device, and the second error detection and correction code may be used to mitigate single event upset induced single and multiple bit flips within a page of a memory device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a computing system in accordance with various embodiments;

FIG. 2 shows a block diagram of an exemplary processing/memory module in accordance with various embodiments;

FIG. 3 shows a block diagram of an exemplary memory module in accordance with various embodiments;

FIG. 4 shows a block diagram of another exemplary memory module in accordance with various embodiments;

FIG. 5 shows a block diagram of pages of data and error correction and detection data within a memory device in accordance with various embodiments;

FIG. 6 shows exemplary operational steps of a method in accordance with various embodiments; and

FIG. 7 shows exemplary operational steps of a method in accordance with other various embodiments.

### DETAILED DESCRIPTION

Methods, systems, and devices for error detection and correction are provided. Error correction and detection may be performed across multiple dimensions of memory storage, such as across two or more complete memory devices, as well as within individual pages of memory within a single memory device. Error correction and detection performed across two or more complete memory devices may mitigate single event functional interrupts that affect a complete memory device. Error detection and correction performed within individual pages of memory may be used to mitigate single event upset induced single and multiple bit flips within a page of a memory device. A parallel block code, such as a parallel block Reed-Solomon code, may be used for error correction and detection performed across two or more complete memory devices. A serial block code, such as a serial block Reed-Solomon code, may be used for error correction and detection within individual pages of memory within a single memory device. Serial or parallel block codes that may be used may include any suitable type of error correcting code, such as, for example, Reed-Solomon, Hamming, cyclic error-correcting codes such as BCH, forward error correction codes such as turbo codes, low density parity check (LDPC) codes, and triple majority voting (TMV), etc. Such multi-dimensional error detection and correction may be used for the mitigation of space radiation effects in a satellite system, for example. Such error correction and detection may also be used in other applications that require a highly fault-tolerant system.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Referring first to FIG. 1, a block diagram illustrates an example of a satellite system 100 in accordance with various embodiments. While general aspects of the disclosure are described with reference to exemplary satellite systems, it will be understood that systems and methods described herein may be used in other systems as well, such as other types of space vehicles or systems, as well as terrestrial systems that may be deployed in harsh environments or require relatively high fault tolerance. The system 100 includes a satellite body 105 which may be coupled to one or more solar arrays and/or sensors 110. Communications to and from the satellite 100 may be transmitted/received via an antenna system 115. A processing/memory module 120 may include a distributed computing system 125, and a memory 130 that contains software 135 for execution by one or more processors within the distributed computing system 125. The satellite system 100 also includes primary and redundant controllers 140 and 145, which are coupled with primary and redundant command/telemetry modules 150 and 155. Having primary and redundant systems allows for a system that may withstand one or more faults in the system and continue operations. In some embodiments, the distributed computing system 125 includes primary and redundant components that allow for continued system operation even in the event of one or more malfunctions or faults within the distributed computing system 125. The satellite system 100 may also include one or more communications module(s) 155, and one or more sensor module(s) 160.

According to various embodiments, system 100 may withstand one or more faults and continue uninterrupted operations. Faults can arise from numerous sources in a particular application environment, such as from the interaction of ionizing radiation with one or more of the processors or memories. In particular, faults can arise from the interaction of ionizing radiation with electronic components, such as processors, controllers, and/or memories, in the space environment. It should be appreciated that ionizing radiation can also arise in other ways, for example, from impurities in solder used in the assembly of electronic components and circuits containing electronic components. These impurities typically cause a very small fraction (e.g., <<1%) of the error rate observed in space radiation environments. Additionally, memory components may have random bit flips that may result in a fault or data corruption if not corrected.

With respect to radiation effects, these effects may induce one or more types of errors in electronic components, and may occur at any point in the mission duration. Such radiation effects include single event upset (SEU), multiple bit upset (MBU), single event functional interrupt (SEFI), and single event transient (SET) errors. SEU, MBU, SEFI and SET can require mitigation at the board and/or system level. Memory and processing systems of the processing/memory module 120, according to various embodiments, are configured to perform multi-dimensional error detection and correction for data stored in memory, and thereby mitigate effects of SEU, MBU, SEFI, and/or SET type errors.

Various embodiments can be constructed and adapted for use in a space environment, generally considered as 50 km altitude or greater, and included as part of the electronics system of one or more of the following: a satellite, or spacecraft, a space probe, a space exploration craft or vehicle, an avionics system, a telemetry or data recording system, a communications system, or any other system where memory storage may be useful. Additionally, embodiments may be constructed and adapted for use in a manned or unmanned aircraft including avionics, a unmanned aerial vehicle (UAV), telemetry, communications, navigation systems or a system for use on land or water.

With reference now to FIG. 2, a block diagram illustration 200 of a processing/memory module 120-a in accordance with various embodiments is described. In the example of FIG. 2, the processing/memory module 120-a includes one or more processing module(s) 205, a memory module 210, and an error detection and correction (EDAC) module 215. The processor module(s) 205 may include one or more processors, such as a primary and redundant processors that may be coupled with other system components through a backplane. Processor module(s) 205 may be coupled with one or more data busses to transfer data to and from the processing/memory module 120-a. Memory module 210 may include, for example, multiple memory devices that are sued to store data, with each of the memory devices configured to store data in a predefined plurality of memory pages within the device. Memory module 210 may, for example, include a number of memory devices that store data in pages of memory within each device. EDAC module 215 is coupled with the processor module(s) 205 and memory module 210 and configured to perform first error detection and correction encoding on data to be stored across multiple memory devices within memory module 210, and to perform second error detection and correction encoding of data to be stored within pages of data to be stored within one or more of the memory devices within memory module 210.

In some embodiments, the first error detection and correction is performed using a parallel block code encoded across the plurality of memory devices of memory module 210. For example, if memory module 210 includes a large number of flash memory devices, blocks of code stored across several of the devices may be encoded by the EDAC module 215. Thus, if one of the devices fails, the missing data from that device may be corrected using the parallel block code. This error correction and detection may thus be used to mitigate SEFIs that affect a complete memory device. This first error detection and correction may be an error detection and correcting code that encodes data stored across several devices of memory module 210. According to some other embodiments, the first error detection and correction code may include serial block code (rather than a parallel block code) encoded across the plurality of memory devices. The second error detection and correction, in some embodiments, is performed using a serial block code encoded in the plurality of pages within the one or more memory devices of memory module 210, and may be used to mitigate single event upset induced single and multiple bit flips within a page of a memory device within memory module 210. The serial block code of the second error detection and correction may be an error detection and correcting code that encodes data within a page of data stored within a memory device. According to some embodiments, the second error detection and correction code may include parallel block code for encoding of data stored within a page of data within the one or more memory devices. In some embodiments, the data encoded using the serial and/or parallel block code is stored within each memory device in spare memory storage at the end of each memory page.

Thus, embodiments provide an efficient implementation for a robust error detection and correction systems and methods. Embodiments employing such error correction and detection may allow the use of a smaller quantity of memory and/or fewer processing resources (such as resources within a FPGA) than possible with traditional error correction and detection. Using error detection and correction algorithms across multiple dimensions of a memory system to correct for multiple classes of error mechanisms in spacecraft memory systems may thus provide for robust and efficient spacecraft, where efficient use of resource is highly desirable. The systems and methods of various embodiments of this disclosure also fit well in current flash memory devices by utilizing the spare memory storage at the end of each flash memory page to store the check symbols for the serial block codes on each memory device.

Referring now to FIG. 3, a block diagram 300 illustrates an example of a memory module 210-a in accordance with various embodiments. In the example of FIG. 3, a memory controller 305 is coupled with memory device A 310 through memory device N 320. Memory module 210-a may be implemented as a memory board that is to be used in conjunction with other components of a system. In one embodiment a flash memory board includes components of memory module 210-a. The memory module 210-a is coupled with EDAC module, and data stored in the memory module 210-a may be processed using parallel and serial block codes to mitigate errors that may occur. In one embodiment, a Reed-Solomon parallel block code is used to encode data stored in corresponding memory address ranges for each of the memory devices 310 through 320. As noted above, however, any suitable type of error correcting code may be used to encode the stored data, such as, for example, Reed-Solomon, Hamming, cyclic error-correcting codes such as BCH, forward error correction codes such as turbo codes, low density parity check (LDPC) codes, and triple majority voting (TMV), etc. In such a manner, by using the concept of multi-dimensional EDAC algorithms the error modes in flash memory arrays that are unique to a spacecraft environment can be mitigated while efficiently utilizing the memory devices. The multi-dimensional EDAC algorithm, according to various embodiments, implements a parallel block code across the width of the flash memory data bus to effectively mitigate SEFIs that corrupt complete devices, blocks, or pages of the memory array. For example, the case of a 128-bit data word bus width a (18,16) EDAC code could be used for the parallel block code thereby increasing the overall bus width to 144-bits or 18 devices. In other examples, a 192-bit data word bus width could utilize a (26,24) EDAC code while a 256-bit data word bus width could utilize a (34,32) EDAC code. Additionally, data within each memory device 310 through 320 is encoded with a Reed-Solomon serial block code, with check symbols for the serial block codes stored at the end of each page of memory. For example, in addition to the parallel block code Implemented across the data word, a byte serial code may be used to encode the data stored in the pages of each device. Such a code may effectively mitigate any inherent flash random bit flips in each page and any radiation induced single or multiple bit upsets. The byte serial code, in some examples, uses the flash spare memory area in each page to store the check symbols for the code. An example is a 8-Gbit flash part with page size of 2K+64 bytes. A (255,249) EDAC code, for example, may be used this page size enabling the storage of 9 serial codeword per page. The 9 codewords of such an example require 54 of the 64 spare bytes per flash page. A further example is that of a 16-Gbit flash with page size of 4K+128 bytes. Again a (255,249) EDAC code may work well with such a page size enabling the storage of 17 serial codewords per flash page. The 17 codewords of such an example require 102 of the 128 spare bytes per flash page.

With reference now to FIG. 4, a block diagram 400 illustrates an example of a memory module 210-b in accordance with various embodiments. Memory module 210-b may be implemented as a memory board that is coupled with other system components of a satellite (or other system). In the example of FIG. 4, a memory controller 405 is coupled with flash array A 410 and flash array B 415. Memory controller 405, in this embodiment, includes primary and redundant backplane/EDAC interfaces, thus allowing for a failure in one of the interfaces while maintaining system operation. Flash arrays A and B 410, 415, may each include a number of memory devices, and in one embodiment each include approximately 500 Gigabyte capacity utilizing 8 gigabit memory die. Thus, flash arrays A and B 410, 415, provide a combined one terabyte capacity. Memory module 210-a bay also include one or more spare memory devices, which may be enabled upon failure of a memory device within a memory array 410 or 415. In one embodiment, flash controller 405 provides a write bandwidth of 5 Gbps, and a read bandwidth of 4 Gbps. Memory module 210-a also includes other components to provide a robust and efficient storage platform, including a pointer FIFO buffer 420 and configuration data 425. Such an architecture may provide a fault tolerant, highly reliable, and high performance system that may be used in harsh environmental conditions such as may be encountered in a space environments.

As mentioned, above, various embodiments use serial block code to encode data stored within pages of data in a memory device. With reference now to FIG. 5, a block diagram 500 of a memory device 505 is described for embodiments. Memory device 505 may be, for example, a NAND-based flash memory device that stores pages 510 through 530 of data. At the end of each page 510 through 530, the memory device 505 may include some spare memory at the end of each page 510 through 530. In some embodiments, EDAC check symbols 535 through 555 may be stored at the end of each page 510 through 530 in such spare memory. Thus, efficient use of the memory device 505 may be accomplished while providing robust fault tolerance.

With reference now to FIG. 6, a flow chart illustrating the operational steps 600 of various embodiments is described. The operational steps 600 may, for example, be performed by one or more components of FIGS. 1-5, or using any combination of the devices described for these figures. Initially, at block 605, data to be stored in a number of different memory devices is received. At block 610, data to be stored across a plurality of the memory devices is encoded according to a first error detection and correction code. The first error detection and correction code may be, for example, a parallel block code encoded across the number of memory devices. According to some other embodiments, the first error detection and correction code may include serial block code (rather than a parallel block code) encoded across the plurality of memory devices. The first error detection and correction code may mitigate single event functional interrupts that affect a complete memory device. Finally, at block 615, data to be stored in one or more pages of data within a memory device is encoded according to a second error detection and correction code. The second error detection and correction code may be a serial block code for encoding of data stored within a page of data within the one or more memory devices. According to some embodiments, the second error detection and correction code may include parallel block code for encoding of data stored within a page of data within the one or more memory devices. The second error detection and correction code may mitigate single event upset induced single and multiple bit flips within a page of a memory device. As discussed above, the memory devices may be or more arrays of flash-based memory devices, and the first and second encoding may mitigate space radiation effects on the memory devices.

With reference now to FIG. 7, a flow chart illustrating the operational steps 700 of various embodiments is described. The operational steps 700 may, for example, be performed by one or more components of FIGS. 1-5, or using any combination of the devices described for these figures. Initially, at block 705, data to be stored in a number of different memory devices is received. At block 710, data to be stored across a plurality of the memory devices is encoded according to a first error detection and correction code. Similarly as discussed above, the first error detection and correction code may be a parallel or serial block code encoded across the number of memory devices. At block 715, data to be stored in one or more pages of data within a memory device is encoded according to a second error detection and correction code. Similarly as discussed above, the second error detection and correction code may be a serial or parallel block code (e.g., a Reed-Solomon code) for encoding of data stored within a page of data within the one or more memory devices. As discussed above, the memory devices may be or more arrays of flash-based memory devices, and the first and second encoding may mitigate space radiation effects on the memory devices.

At block 720, encoded data is stored in memory devices. At a later time, data is retrieved from memory devices, as indicated at block 725. At block 730, single event functional interrupts affecting a complete memory device are corrected using the first encoded data. Such correction may use the encoded data to determine any erroneous or missing bits in the data. Finally, at block 735, single and multiple bit flips within a page of a memory device are corrected using the second encoded data. Such correction may use the encoded data to correct erroneous bit(s) in the data. Such errors in data or device failures may be the result of any of a number of situations. For example, in systems operating in a space environment, radiation effects such as described above may impact a memory device, or one or more bits stored within a memory device, resulting in a fault with respect to data stored in the memory devices. The methods described with respect to FIGS. 6 and 7 may mitigate the effects of such faults, thus providing an efficient and robust system.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described components and techniques. These techniques, however, may be practiced without these specific details. In some instances, well-known structures and devices are shown in block diagram form in order to avoid obscuring the concepts of the described embodiments.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A processing system, comprising:
a processor module;
a memory module coupled to the processor module comprising a plurality of memory devices, each of the memory devices configured to store data in a predefined plurality of memory pages within the device; and
an error detection and correction module coupled with the processor module and memory module and configured to perform first error detection and correction encoding on data to be stored across a plurality of the memory devices and second error detection and correction encoding of data to be stored within pages of data to be stored within one or more of the plurality of memory devices.

2. The apparatus of claim 1, wherein the first error detection and correction is performed using a parallel block code encoded across the plurality of memory devices.

3. The apparatus of claim 1, wherein the first error detection and correction is performed using a serial block code encoded across the plurality of memory devices.

4. The apparatus of claim 1, wherein the second error detection and correction is performed using a serial block code encoded in the plurality of pages within the one or more memory devices.

5. The apparatus of claim 1, wherein the second error detection and correction is performed using a parallel block code encoded in the plurality of pages within the one or more memory devices.

6. The apparatus of claim 5, wherein the encoded data is stored within each of the subset of memory devices including spare memory storage at the end of each memory page.

7. The apparatus of claim 1, wherein the first error detection and correction encoding is configured to mitigate single event functional interrupts that affect a complete memory device.

8. The apparatus of claim 1, wherein the second error detection and correction encoding is configured to mitigate single event upset induced single and multiple bit flips within a page of a memory device.

9. The apparatus of claim 1, wherein the plurality of memory devices comprise one or more arrays of flash-based memory devices.

10. The apparatus of claim 1, wherein the first and second error detection and corrections are configured to mitigate space radiation effects on the plurality of memory devices.

11. A method for error detection and correction, comprising:
receiving data to be stored in a memory module, the memory module comprising a plurality of memory devices, each of the memory devices configured to store data in a predefined plurality of memory pages within the device;
firstly encoding data to be stored across a plurality of the memory devices according to a first error detection and correction code; and
secondly encoding data to be stored in one or more pages of data within one or more of the plurality of memory devices according to a second error detection and correction code.

12. The method of claim 11, wherein the first error detection and correction code comprises a parallel block code encoded across the plurality of memory devices.

13. The method of claim 11, wherein the first error detection and correction code comprises a serial block code encoded across the plurality of memory devices.

14. The method of claim 11, wherein the second error detection and correction code comprises a serial block code for encoding of data stored within a page of data within the one or more memory devices.

15. The method of claim 11, wherein the second error detection and correction code comprises a parallel block code for encoding of data stored within a page of data within the one or more memory devices.

16. The method of claim 11, wherein the first error detection and correction code is configured to mitigate single event functional interrupts that affect a complete memory device.

17. The method of claim 11, wherein the second error detection and correction code is configured to mitigate single event upset induced single and multiple bit flips within a page of a memory device.

18. The method of claim 11, wherein the plurality of memory devices comprise one or more arrays of flash-based memory devices.

19. The method of claim 11, wherein the firstly and secondly encoding is configured to mitigate space radiation effects on the plurality of memory devices.
